(19) United States
(12) Patent Application Publication
(10) Pub. No.: US 2003/0128304 A1
(43) Pub. Date: Jul. 10, 2003

(54) Projection lens unit of projection television

(75) Inventors: Sung-Min Park, Suwon-si (KR); Jeong-Ho Nho, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/337,864

(22) Filed: Jan. 8, 2003

(30) Foreign Application Priority Data
Jan. 9, 2002 (KR) 2002-1207

(51) Int. Cl. H04N 9/31

(52) U.S. Cl. 348/781

(57) ABSTRACT

A projection lens unit of a projection television (TV) includes a first lens group for focusing an image incident from an image generating source, a reflection mirror for reflecting the image projected from the first lens group, and a second lens group having the same optical axis as the optical axis of the first lens group for magnifying and projecting the image reflected from the reflection mirror to a screen. The first and second lens groups are installed in first and second single bodies, which are coupled to a third single body having the reflection mirror to reflect the image incident from the first single body to the second single body. By this arrangement, the focus of the projection lens unit is easily adjusted and the lens groups are conveniently coupled to each other. In addition, a defocused state of the projection lens unit can be easily minimized.

### BACKGROUND OF THE INVENTION

1. Field of the Invention

The present invention relates to a projection device for projecting an image generated by an image generating source to a frontal screen so as to display the image on the screen, and more particularly, to a projection lens unit for magnifying and projecting an image to a screen.

2. Description of the Related Art

Image projection devices, such as projection televisions (TV) or video projectors, magnify and project images to a screen through a projection lens unit in order to display the images. Therein, the images are generated by an image generating device, such as a liquid crystal device (LCD) or a small-sized cathode ray tube (CRT). As widely known, image projection devices are divided into front-type image projection devices and rear-type image projection devices according to the method used to magnify and project the images generated by the image generating device.

FIGS. 1 and 2 illustrate conventional front-type liquid crystal projection devices. More specifically, FIG. 1 illustrates a three-panel liquid crystal projection device having three liquid crystal panels 15, 16, and 17. The three liquid crystal panels 15, 16, and 17 divide a white beam, which is projected from a light source 10, into three colored wave beams, namely a red (R) wave beam, a green (G) wave beam, and a blue (B) wave beam, by using color breakup dichroic mirrors 11, 12, 13, and 14, so as to generate image signals corresponding to each color. FIG. 2 illustrates a single panel liquid crystal projection device having one liquid crystal panel 23, which includes a color filter to form color images. In FIG. 1, reference numeral 1 denotes a set case, and reference numeral 10 denotes a light source, while reference numerals 18 and 19 denote reflection mirrors. In FIG. 2, reference numeral 2 denotes a set case, and reference numerals 20, 21, and 22 denote a light source, a heat ray removal filter, and a reflection mirror, respectively.

In the conventional front-type liquid crystal projection devices shown in FIGS. 1 and 2, a lens group L is arranged in a straight line, as shown in the expanded view of FIG. 3. The lens group L is included in a projection lens unit 30 that magnifies and projects the images formed by the liquid crystal panels 15, 16, 17, and 23 to a screen S located in a front direction. Accordingly, a main optical axis of an image beam that is projected from the projection lens unit 30 is projected toward the screen S in a straight line. In the above-described straight line optical arrangement structure, due to the focus distance of the lens group L, there exists a limit in reducing size and weight of the projection device, because the focus of the image beam projected from the projection lens unit 30 has to be adjusted so as to be formed on the screen S. Moreover, a defocused state of the projection lens unit 30 may exceed a certain permissible limit when the lenses of the lens group L are arranged. In particular, the depths D1 and D2 of the set cases 1 and 2 of the front-type liquid crystal projection devices are great, so that the front-type liquid crystal projection devices are not suitable as wall-type projection devices in a house. Accordingly, a projection lens unit formed of a first lens group L1, a reflection mirror M, and a second lens group L2 is provided to reduce the set depth of the projection device, as shown in FIG. 4. In this case, the first lens group L1 is provided to focus an image generated by an image generating source (not shown). The reflection mirror M converts or alters the axis of the image passed through the first lens group L1 by a predetermined angle; and the second lens group L2 magnifies and projects the image reflected from the reflection mirror M to a screen.

However, problems related to the arrangement of the first and second lens groups L1 and L2 and the reflection mirror M remain so that the optical axis may alter or the defocused state of the arrangement may be increased.

### SUMMARY OF THE INVENTION

To solve the above-described problems, it is an objective of the present invention to provide a projection lens unit of a projection television (TV), wherein the extent of a defocused state of the projection lens can be minimized through a convenient and suitable arrangement of lens groups and of a reflection mirror provided therebetween; through a convenient assembly of the projection lens unit; and through an easy adjustment of the defocused state of the projection lens unit.

To accomplish this and other objectives of the present invention, a projection lens unit of a projection TV includes a first lens group for focusing an image incident from an image generating source; a reflection mirror for reflecting the image projected from the first lens group; and a second lens group having the same optical axis as the optical axis of the first lens group for magnifying and projecting the image reflected from the reflection mirror to a screen. The first and second lens groups are installed in first and second single bodies, which are coupled to a third single body that includes the reflection mirror to reflect the image incident from the first single body to the second single body.

The first and second single bodies are coupled to first and second coupling portions, which are integral parts of the third single body. Therein, the first single body and the first coupling portion and/or the second single body and the second coupling portion are coupled to each other by a screw coupling method.

According to an exemplary embodiment of the present invention, the first single body and the first coupling portion are coupled to each other via a first coupling device that serves as a coupling medium. The first coupling device is coupled to the first coupling portion by using the first coupling device as a male screw and by using the first coupling portion as a female screw. In addition, the first single body is coupled to the first coupling device by using the first single body as a male screw and by using the first coupling device as a female screw. In addition, the first single body and the first coupling device are coupled by screws that are arranged perpendicular or parallel to the optical axis.

The second single body is coupled to the second coupling portion by using the second single body as a male screw and by using the second coupling portion as a female screw. Further, the second single body and the second coupling portion are coupled by screws that are arranged perpendicular or parallel to the optical axis.

According to another exemplary embodiment of the present invention, the second single body and the second coupling portion are coupled to each other by using a second coupling device as a coupling medium, which is coupled to the second coupling portion. Here, the second coupling device is coupled to the second coupling portion by using the second coupling device as a male screw and by using the second coupling portion as a female screw. In addition, the second single body is coupled to the second coupling device by using the second single body as a male screw and by using the second coupling device as a female screw. Therein, the second single body and the second coupling device are coupled by screws that are arranged perpendicular or parallel to the optical axis.

According to another embodiment of the present invention, the second single body is coupled to the second coupling portion by using the second single body as a female screw and by using the second coupling portion as a male screw. Here, the second single body and the second coupling portion are further coupled to each other by screws that are arranged perpendicular to the optical axis.

In a further exemplary embodiment of the present invention, the second coupling device is formed of a material that has a predetermined thermal expansion coefficient. In addition, the third single body is attached to the inner surface of the second coupling portion.

The reflection mirror may be installed on the inner surface of the third single body or, though a separate structure, on the outer surface of the third single body.

In the projection lens unit according to exemplary embodiments of the present invention, lens groups, which focus and project an image generated by an image generating source to a screen, are installed in single bodies, while a reflection mirror is installed in the same single body. Consequently, the lens groups and the reflection mirror are conveniently arranged. In addition, the single bodies are coupled to each other and are able to rotate so as to adjust the focus of the projection lens unit. Thereby, the extent of a defocused state of the projection lens unit is minimized.

According to another exemplary formulation of the present invention, a projection TV includes an image generating source for generating an image; a first body, which includes a first lens assembly for receiving and focusing the image generated by the image generating source; a reflection mirror for receiving and reflecting the image focused by the first lens assembly; a second body, which includes a second lens assembly for receiving, magnifying, and projecting the image reflected from the reflection mirror; and a screen onto which the image magnified and projected by the second lens assembly is displayed. Therein, a third body, which includes the reflection mirror, is connected to the first body and to the second body; the first lens assembly has a first optical axis; and the second lens assembly has a second optical axis that is identical to the first optical axis of the first lens assembly.

### BRIEF DESCRIPTION OF THE DRAWINGS

The above and other objectives and advantages of the present invention will become more apparent by describing in detail exemplary embodiments thereof with reference to the attached drawings, in which:

FIG. 1 is a schematic structural view illustrating a conventional front-type three-panel liquid crystal projection device;

FIG. 2 is a schematic structural view illustrating a conventional front-type single panel liquid crystal projection device;

FIG. 3 is a schematic structural view illustrating an optical arrangement of a projection unit of the liquid crystal devices shown in FIGS. 1 and 2;

FIG. 4 is a schematic structural view illustrating another conventional projection lens unit;

FIG. 5 is a side view illustrating a structure of a projection lens unit of a projection television (TV) according to an exemplary embodiment of the present invention;

FIGS. 6 through 10 are a side view (FIG. 6), sectional views (FIGS. 7, 8, and 9), and a perspective view (FIG. 10) illustrating a first single body of the projection lens unit of FIG. 5 according to various embodiments of the present invention;

FIGS. 11 through 13 are side views (FIGS. 11 and 13) and a sectional view (FIG. 12) illustrating a second single body of the projection lens unit of FIG. 5 according to various embodiments of the present invention;

FIG. 14 is a perspective view illustrating a reflection portion of the projection lens unit shown in FIG. 5 according to an exemplary embodiment of the present invention;

FIG. 15 is a side view illustrating the reflection portion of FIG. 14;

FIG. 16 is a side view illustrating a reflection portion of the projection lens unit shown in FIG. 5 according to another exemplary embodiment of the present invention;

FIG. 17 is a perspective view illustrating a reflection portion of the projection lens unit shown in FIG. 5 according to yet another exemplary embodiment of the present invention;

FIG. 18 is a side view illustrating a reflection mirror attached to an inner surface of a portion at which first and second coupling portions meet; and

FIG. 19 is a perspective view illustrating each component of the projection lens unit according to an exemplary embodiment of the present invention.

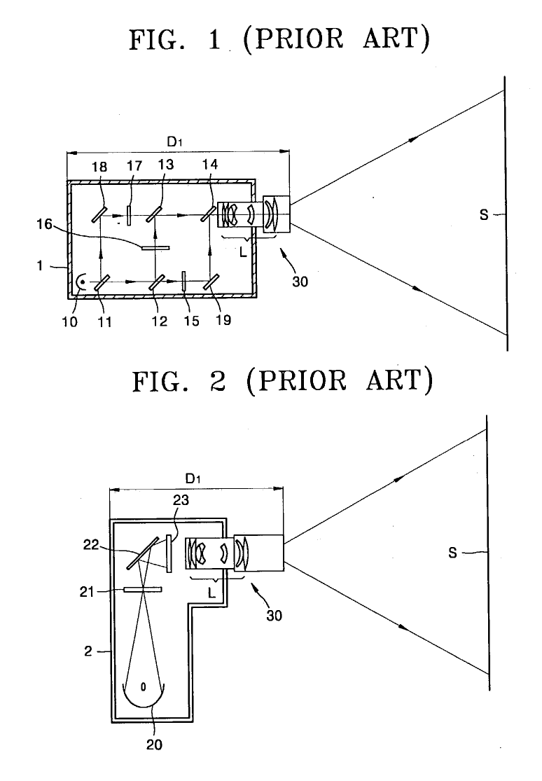

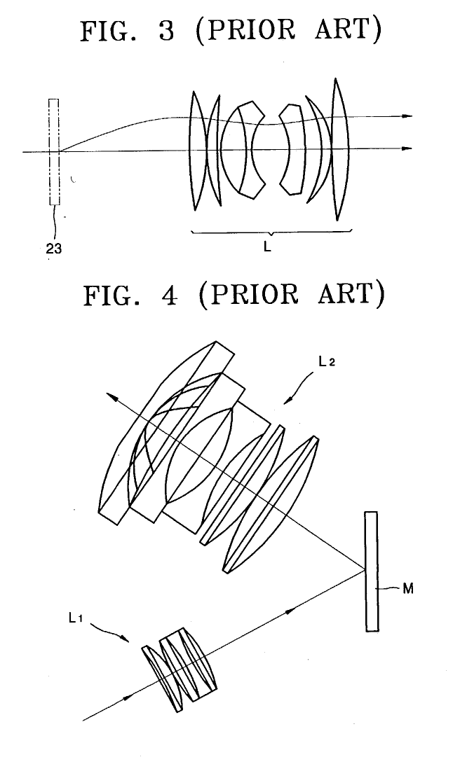

### DETAILED DESCRIPTION OF EXEMPLARY EMBODIMENTS OF THE INVENTION

A projection lens unit of a projection television (TV) according to the present invention will be described in detail with reference to the attached drawings. In the drawings, the thickness of the layers and regions are exaggerated for clarity.

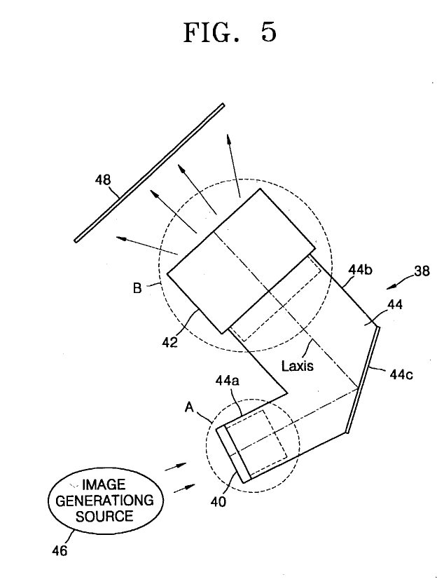

Referring to FIG. 5, a projection lens unit 38 according to an embodiment of the present invention is formed of first through third single bodies 40, 42, and 44. The first single body 40 focuses a beam, namely an image having predetermined image information generated by an image generating source 46, i.e., a liquid crystal device (LCD) or a cathode ray tube (CRT), to a reflection portion 44c arranged in the third single body 44. The first single body 40 includes a first lens group (not shown) having positive power. It is preferable that the first lens group is formed of at least one convex lens, at least one concave lens, and an aspheric lens for adjusting an optical axis so as to solve or relieve an optical aberration problem. The first single body 40 is coupled to a first coupling portion 44a of the third single body 44, namely a first barrel.

The first single body 40 is coupled to the first coupling portion 44a of the third single body 44 by a first, second, or third screw coupling method. In this case, the first screw coupling method uses separate screws, the second screw coupling method uses the first single body 40 as a male screw and the first coupling portion 44a as a female screw, and the third screw coupling method uses both the first and second screw coupling methods.

In the first screw coupling method, the screws couple the first single body 40 and the first coupling portion 44a to each other, wherein the screws are arranged perpendicular or parallel to the optical axis that connects the image generating source 46 and the reflection portion 44c. Therein, the reflection portion 44c of the third single body 44 includes a reflection mirror.

In another exemplary embodiment, the first single body 40 is coupled to the first coupling body 44a by a first coupling device, which is coupled to the first coupling body 44a, as a coupling medium. In this case, the first coupling device is coupled to the first coupling portion 44a by using the first coupling device as a male screw and by using the first coupling portion 44a as a female screw. The first single body 40 is coupled to the first coupling device by the second screw coupling method.

The method for coupling the first coupling portion 44a of the third single body 44 to the first single body 40 will be described in detail with reference to the drawings.

A second single body 42 magnifies and projects the image reflected from the reflection portion 44c of the third single body 44 to a screen 48 arranged in front direction. A second lens group (not shown), which is successively arranged for magnifying and projecting the image, is fixedly installed in the second single body 42. It is preferable that the second lens group has negative power and is formed of at least one of the following lenses: convex lens, meniscus lens, concave lens, and aspheric lens. It is further preferable that the optical axes of the first and second lens groups are identical. The second single body 42 is coupled to a second coupling portion 44b of the third single body 44, namely a second barrel, which forms a predetermined angle with the first coupling portion 44a. The method for coupling the second single body 42 to the second coupling portion 44b is similar to the method for coupling the first single body 40 to the first coupling portion 44a, which will be described in detail with reference to the drawings.

The third single body 44, to which the first and second single bodies 40 and 42 are coupled, is used as an optical axis conversion device. In other words, the third single body 44 converts the progressive direction of the image incident from the first lens group of the first single body 40, so that the image is incident on the second single body 42. The third single body 44 is formed of the first and second coupling portions 44a and 44b, which are connected and which form a predetermined angle, and the reflection portion 44c, which directs the first and second coupling portions 44a and 44b and which is formed at a portion in which the first and second coupling portions 44a and 44b meet.

Reference signs A and B in FIG. 5 respectively denote a first coupling region where the first single body 40 and the first coupling portion 44a are coupled to each other, and a second coupling region where the second single body 42 and the second coupling portion 44b are coupled to each other.

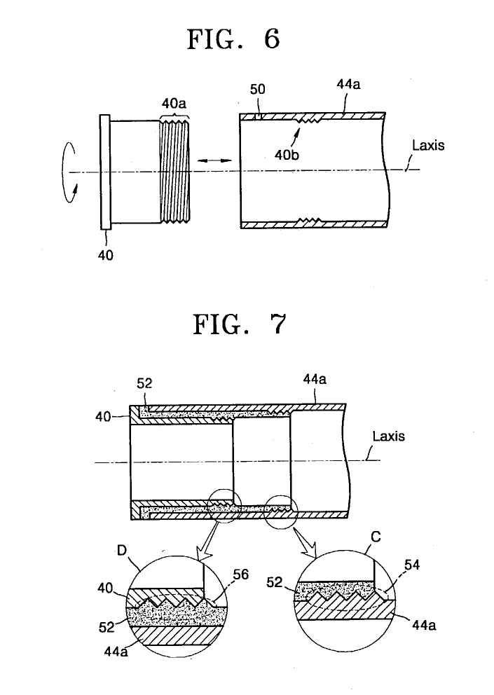

FIG. 6 illustrates the first single body 40 together with a portion of the first coupling portion 44a, which form the first coupling region A. Referring to FIG. 6, an end portion of the first single body 40, which is inserted into the first coupling portion 44a, has a first male screw portion 40a formed of screw threads and valleys. The inner circumference of the first coupling portion 44a, which corresponds to the end portion of the first single body 40, has a first female screw portion 40b formed of screw threads and valleys that fit with the first male screw portion 40a. Accordingly, the first single body 40 and the first coupling portion 44a are coupled by using the first single body 40 as a male screw and by using the first coupling portion 44a as a female screw.

The projection lens unit 38 formed of the first through third single bodies 40, 42, and 44 is designed to optimize the quality of the image projected to the screen 48. In addition, the first through third single bodies 40, 42, and 44 are designed to be injection molded.

Consequently, if the image is projected to the screen 48 after coupling the first and second single bodies 40 and 42 to the third single body 44, the quality of the projected image may be optimized. However, the image quality projected to the screen 48 may deteriorate from the initial state of optimum quality when the projection lens unit and other components are assembled to form the projection TV, or when the projection TV is moved or operated. It is preferable that the first single body 40 is moved along the optical axis Laxis for a predetermined distance in order to adjust the focus of the image so that the quality of the image projected to the screen 48 is optimized. Consequently, it is preferable that the lengths of the first male screw portion 40a and the first female screw portion 40b are longer than the distance for which the first single body 40 is moved along the optical axis Laxis in order to adjust the focus of the image.

The projection lens unit 38 including the first through third single bodies 40, 42, and 44 is fixed in the projection TV. Although the second screw coupling method, which uses the first single body 40 as a male screw and the first coupling portion 44a as a female screw, completely couples the first single body 40 to the first coupling portion 44a, it is preferable that the first single body 40 and the first coupling portion 44a are further coupled to each other by screws after the first single body 40 is moved from an initial position. In this case, the screws proceed in a direction perpendicular to the optical axis Laxis in order to more completely couple the first single body 40 to the first coupling portion 44a, or in order to adjust the focus of the projection lens unit 38. To this end, a screw groove 50 is formed in a space between the inlet of the first coupling portion 44a, into which the first single body 40 is inserted, and the first female screw portion 40b, in order to screw the screw perpendicular to the optical axis Laxis. The screw groove 50 operates as a female screw, namely a nut, for the screw, which can be a bolt. Although, only one screw groove 50 is illustrated in FIG. 6, a plurality of screw grooves may be symmetrically arranged in the first coupling portion 44a.

As described above, the first single body 40 and the first coupling portion 44a may be coupled by the first screw coupling method, the second screw coupling method, or a third screw coupling method, in which the first and second screw coupling methods are combined.

Referring to FIG. 7, a first coupling device 52 is arranged between the first single body 40 and the first coupling portion 44a as a medium for coupling the first single body 40 to the first coupling portion 44a. It is preferable that the first single body 40, the first coupling device 52, and the first coupling portion 44a have the same optical axis Laxis.

The first coupling device 52 and the first coupling portion 44a are coupled to each other by the second screw coupling method. The second screw coupling method for this case is illustrated in a first circle C, which shows an enlarged view of a portion in which the first coupling device 52 and the first coupling portion 44a are coupled to each other. Reference numeral 54 in the first circle C denotes a portion in which the first coupling device 52 and the first coupling portion 44a are coupled to each other by the second screw coupling method.

After the first coupling device 52 and the first coupling portion 44a are completely coupled to each other by the second screw coupling method, the first single body 40 is coupled to the first coupling device 52 by the second screw coupling method. The second screw coupling method is illustrated in a second circle D, which shows an enlarged view of a portion in which the first single body 40 and the first coupling device 52 are coupled to each other. Reference numeral 56 in the second circle D denotes a portion in which the first single body 40 and the first coupling device 52 are coupled to each other by the second screw coupling method.

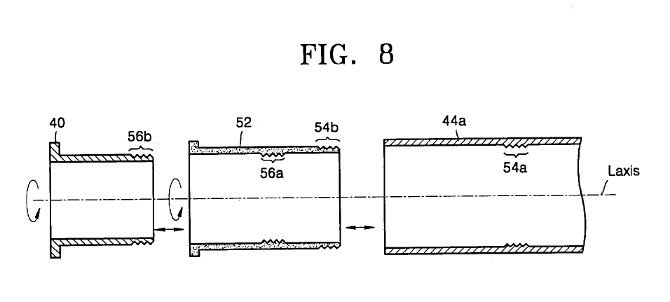

FIG. 8 is a sectional view illustrating a separated state of the first single body 40, the first coupling device 52, and the first coupling portion 44a. In this case, the end of the first coupling device 52 has a second male screw portion 54b, which is coupled to a second female screw portion 54a on the inner circumference of the first coupling portion 44a. The end of the first single body 40 has a third male screw portion 56b, which is coupled to a third female screw portion 56a on the inner circumference of the first coupling device 52.

Although they are not shown in FIG. 8, screw grooves through which screws are coupled for fixing the first single body 40 to the first coupling device 52 and the first coupling portion 44a may be arranged.

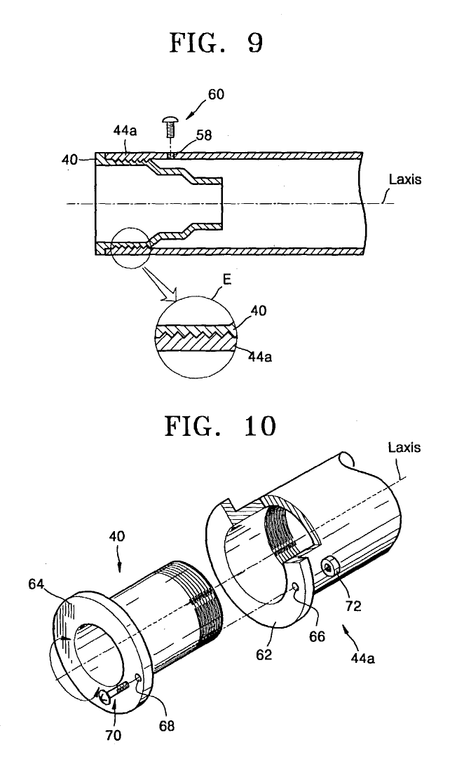

FIG. 9 is a sectional view illustrating a first single body 40 having a different shape. Referring to FIG. 9, the diameter of the first single body 40 is successively reduced toward the reflection portion 44c of FIG. 5. In this case, the external circumference of the portion having the greatest diameter in the first single body 40 contacts the inner circumference of the first coupling portion 44a, and the external circumferences of other portions having smaller diameters in the first single body 40 do not contact the inner circumference of the first coupling portion 44a. Referring to a third circle E, which is an enlarged view of the contact portion of the first coupling portion 44a and the first single body 40, the first coupling portion 44a and the first single body 40 are coupled by the second screw coupling method. Other portions of the first single body 40, which do not contact the first coupling portion 44a, are coupled to the first coupling portion 44a by the first screw coupling method. Therein, a screw groove 58 is formed in the first coupling portion 44a. Reference numeral 60 denotes a bolt used in coupling the first single body 40 to the first coupling portion 44a through the screw groove 58 formed perpendicular to the optical axis Laxis.

FIG. 10 is a perspective view illustrating the case where the first single body 40 and the first coupling portion 44a are coupled to each other by the third screw coupling method, in which a bolt 70 proceeds parallel to the optical axis Laxis.

Referring to FIG. 10, third and fourth through-holes 68 and 66 are formed on rims 64 and 62, respectively. In this case, the rim 64 is formed on the first single body 40 and protrudes outwardly therefrom. The rim 62 is formed on the first coupling portion 44a and protrudes outwardly so as to correspond to the rim 64. In addition, the bolt 70 used in coupling the first single body 40 to the first coupling portion 44a by the first screw coupling method is inserted into the third and fourth through-holes 68 and 66 parallel to the optical axis Laxis. The bolt 70 inserted into the third and fourth through-holes 68 and 66 is fastened by a nut 72.

FIGS. 11 through 13 illustrate methods for coupling the second single body 42, which magnifies and projects the image to the screen 48, to the second coupling portion 44b. These methods are similar to the methods for coupling the first single body 40 to the first coupling portion 44a.

FIG. 11 is a separated view illustrating the case where the second single body 42 and the second coupling portion 44b are coupled to each other by the second screw coupling method. In this case, a portion of the second single body 42, which is inserted into the second coupling portion 44b, has a fourth male screw portion 42a formed of screw threads and valleys. It is preferable that the length of the fourth male screw portion 42a is longer than a distance for moving the second single body 42 along the optical axis Laxis so as to adjust the focus of the image projected to a screen 48 in a projection TV. Corresponding to the fourth male screw portion 42a of the second single body 42, a fourth female screw portion 44d is formed on the inner circumference of the second coupling portion 44b. In this case, the fourth female screw portion 44d is separated from the inlet of the second coupling portion 44b by a predetermined distance toward the inside of the second coupling portion 44b. The fourth female screw portion 44d is formed of screw threads and valleys, which fit to the screw threads and valleys of the fourth male screw portion 42a. The portion of the second single body 42 that is not inserted into the second coupling portion 44b has a diameter greater than that of the second coupling portion 44b.

A second coupling device may be formed between the second coupling portion 44b and the second single body 42 so as to be coupled to both the second coupling portion 44b and the second single body 42. In this case, the second coupling device and the second coupling portion 44b are coupled by using the second coupling device as the male screw and by using the second coupling portion 44b as the female screw. The second coupling device and the second single body 42 are coupled to each other by using the second single body 42 as the male screw and by using the second coupling device as the female screw.

Even though the second coupling device may be coupled to the second coupling portion 44b by the screw coupling method, it is preferable that the second coupling device is permanently coupled to the first coupling portion 44b by injection molding the third single body 44. In this case, it is preferable that the second coupling device is formed of a material having a small thermal expansion coefficient to minimize the deformation of the second coupling device in the injection molding process.

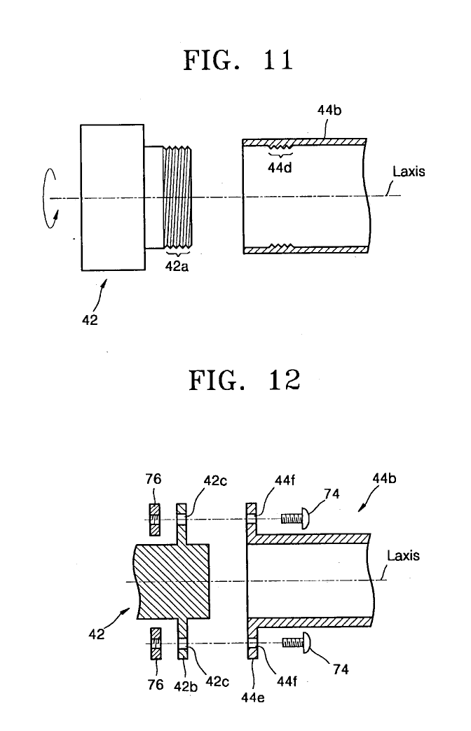

FIG. 12 is a view illustrating the case where the second single body 42 and the second coupling portion 44b are coupled to each other by the first screw coupling method.

Referring to FIG. 12, the second single body 42 and the second coupling portion 44b are coupled to each other by bolts 74 and by nuts 76, which are coupled to the bolts 74. In this case, the bolts 74 penetrate fifth through-holes 42c formed in the second single body 42 and sixth through-holes 44f formed in the second coupling portion 44b. Therein, the fifth through-holes 42c and the sixth through-holes 44f are parallel to the optical axis Laxis. The fifth through-holes 42c are formed on a first rim 42b, which is formed on the external circumference of the first single body 42 and which protrudes perpendicular to the optical axis Laxis. The sixth through-holes 44f are formed in a second rim 44e, which is formed at the inlet of the second coupling portion 44b and which corresponds to the first rim 42b.

If the second single body 42 and the second coupling portion 44b are coupled by the first screw coupling method as shown in FIG. 12, there are, in exemplary embodiments, several methods for coupling the second single body 42 to the second coupling portion 44b.

For example, the second single body 42 and the second coupling portion 44b are aligned so as to align the fifth and sixth through-holes 42c and 44f before the second single body 42 is inserted into the second coupling portion 44b. Then, in the aligned state, the second single body 42 is inserted into the second coupling portion 44b. In another case, the second single body 42 and the second coupling portion 44b are aligned so as to identify the optical axis Laxis. Once aligned, the second single body 42 is inserted into the second coupling portion 44b. In this case, the fifth and sixth through-holes 42c and 44f are not aligned. Thus, the second single body 42 is rotated until a stopping sill (not shown) on the second coupling portion 44b stops the rotation in order to align the fifth and sixth through-holes 42c and 44f. The bolts 74 are inserted into the fifth and sixth through-holes 42c and 44f and fastened by the nuts 76. Accordingly, the second single body 42 and the second coupling portion 44b are coupled to each other.

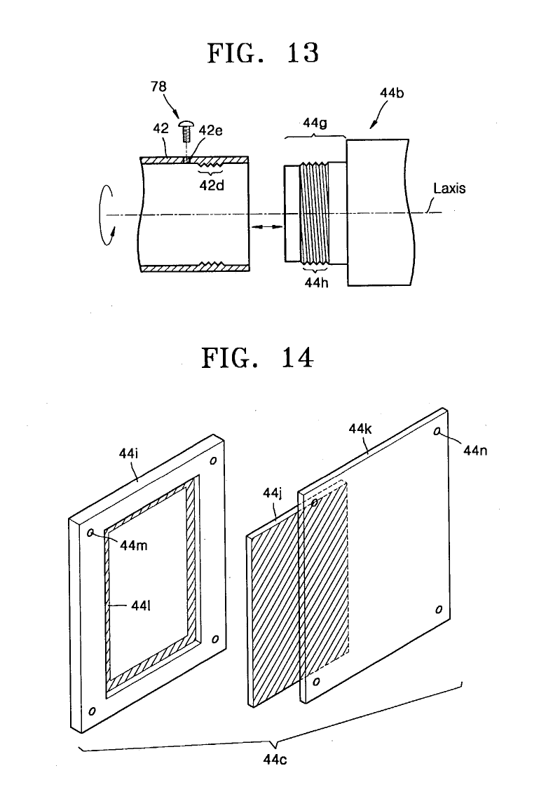

FIG. 13 is a view illustrating a case where the second single body 42 is coupled to the second coupling portion 44b by the third screw coupling method.

Referring to FIG. 13, a portion 44g of the second coupling portion 44b is inserted into the second single body 42. The portion 44g of the second coupling portion 44b that is inserted into the second single body 42 has a fifth male screw portion 44h, which is formed of screw threads and valleys. The inner circumference of the second single body 42 has a fifth female screw portion 42d formed of screw threads and valleys that fit with the screw threads and valleys of the fifth male screw portion 44h. A seventh through-hole 42e is formed in a portion of the second single body 42 farther from the inlet of the second single body 42 than the fifth female screw portion 42d. In this case, the seventh through-hole 42e exposes the front side of the fifth male screw portion 44h of the second coupling portion 44b, when the second coupling portion 44b is inserted into the second single body 42. In order to optimize the quality of the image projected to the screen 48, a bolt 78, which proceeds perpendicular to the optical axis Laxis, is inserted into the seventh through-hole 42e to fix the second single body 42 to the second coupling portion 44b.

Referring to FIG. 14, the reflection portion 44c, which reflects an image forwarded by the first single body 40 to the second single body 42, includes a base 44i and a cover 44k. The base 44i, which is a portion of the third single body 44, includes a contact portion 44l that contacts the edges of the reflection surface of a reflection mirror 44j and is recessed to accommodate the thickness of the reflection mirror 44j. The cover 44k fixes the reflection mirror 44j, which is installed in the base 44i, to the reflection surface in a front direction. The cover 44k includes eighth through-holes 44n through which bolts (not shown) penetrate to couple the base 44i to the cover 44k, and the base 44i includes screw grooves 44m operating as nuts to be coupled to the bolts that penetrate through the eighth through-holes 44n.

FIG. 15 is a side view of the reflection portion 44c, in which the reflection mirror 44j is fixed to the base 44i by coupling the cover 44k to the base 44i with bolts 80.

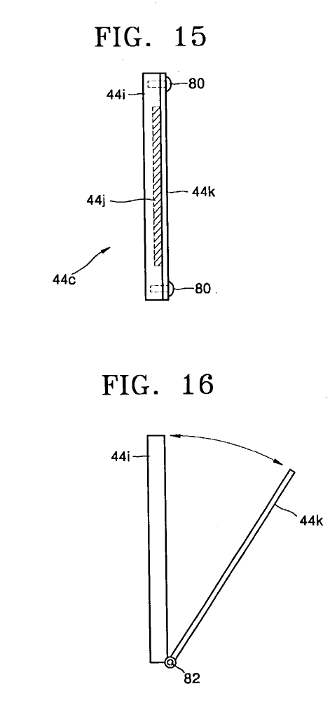

FIG. 16 is a view illustrating the reflection portion 44c according to another exemplary embodiment, which includes the base 44i, in which the reflection mirror 44j is installed, and the cover 44k. In this case, the cover 44k is connected to one side of the base 44i in order to be able to rotate. Reference numeral 82 denotes a connection device, which is similar to a hinge, to connect the cover 44k to the one side of the base 44i and to enable rotation of the cover 44k.

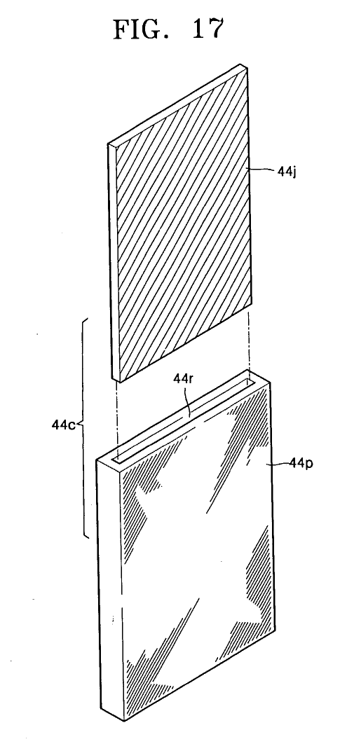

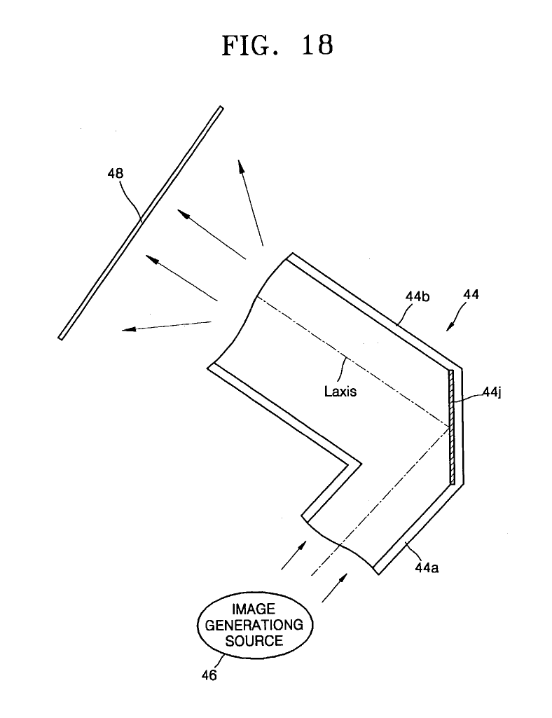

FIG. 17 illustrates the reflection portion 44c according to yet another exemplary embodiment of the present invention. Reference numeral 44p denotes a reflection mirror installation unit into which the reflection mirror 44j is inserted in a sliding manner. The reflection mirror installation unit 44p has a slot 44r into which the reflection mirror 44j is inserted.

Instead of arranging a separate reflection portion 44c at a region where the first and second coupling portions 44a and 44b of the third single body 44 meet so as to install a reflection mirror 44j from the outside, the reflection mirror 44j may be directly installed in the region where the first and second coupling portions 44a and 44b meet, as shown in FIG. 18. Consequently, images generated by the image generating source 46 are precisely reflected to the second single body 42. In this case, the reflection mirror 44j is installed through the first or second coupling portion 44a or 44b before the first single body 40 is coupled to the first coupling portion 44a or the second single body 42 is coupled to the second single body 44b, respectively.

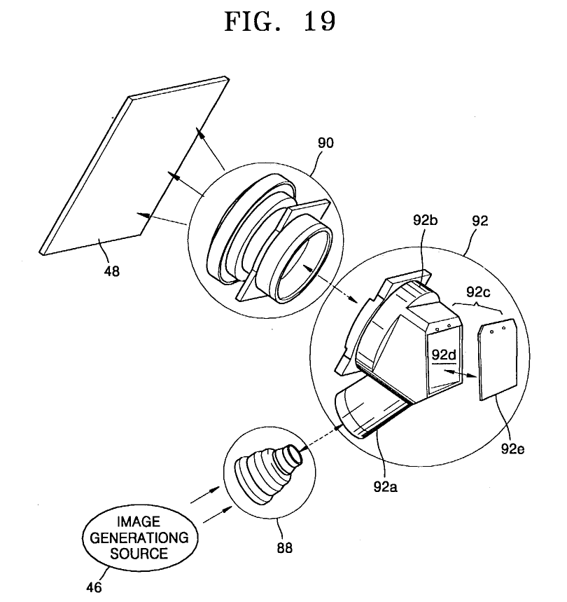

FIG. 19 is a separate perspective view illustrating each portion of a projection lens unit according to an exemplary embodiment of the present invention. Reference numerals 88, 90, and 92 denote first through third single body structures corresponding to the first through third single bodies 40, 42, and 44. Reference numerals 92a and 92b denote portions corresponding to the first and second coupling portions 44a and 44b, respectively. Reference numeral 92c denotes a portion corresponding to the reflection portion 44c; reference numeral 92d denotes a portion to which the reflection mirror 44j is installed; and reference numeral 92e denotes a cover, which covers the portion 92d to which the reflection mirror 44j is installed.

While this invention has been shown and described with reference to exemplary embodiments thereof, the exemplary embodiments described above are merely illustrative and are not intended to limit the scope of the invention. For example, there is the possibility for those skilled in the art to attain a projection lens unit, in which a first coupling portion is separated into first and second parts so that coupling by screws can take place. Further, a first single body can be permanently coupled to the first part to adjust a defocused state of the projection lens unit by rotating the first part. In another embodiment, if the first single body and the first coupling portion are coupled to each other by screws that proceed parallel to an optical axis, through-holes of the first single body and the first coupling portion, into which the screws are inserted, may extend along the outer circumferences of the first single body and the first coupling portion. Accordingly, it will be understood by those skilled in the art that various changes in form and details may be made therein without departing from the spirit and scope of the invention as defined by the appended claims.

As described above, the projection lens unit according to exemplary embodiments the present invention includes the first single body having the first lens group for focusing the image onto the reflection mirror; the second single body having the second lens group for magnifying and projecting the image reflected from the reflection mirror to the screen; and the third single body having the reflection mirror and including the first and second coupling portions, which are respectively coupled to the first and second single bodies by the screw coupling methods. Since the first through third single bodies are designed and injection molded under optimum conditions of the image projected to the screen, the overall focus of the projection lens unit is aligned simply by coupling the first single body to the first coupling portion and by coupling the second single body to the second coupling portion. In addition, assembling the projection lens unit is convenient, while a defocused state of the projection lens unit caused by the assembly is minimized. Since the first and second single bodies are rotationally coupled to the third single body, the defocused state may be conveniently adjusted by rotating the first or second single bodies.

What is claimed is:

1. A projection lens unit of a projection television (TV) including a first lens group for focusing an image incident from an image generating source; a reflection mirror for reflecting the image projected from the first lens group; and a second lens group having an optical axis that is identical to an optical axis of the first lens group for magnifying and projecting the image reflected from the reflection mirror to a screen, wherein
the first and second lens groups are installed in first and second single bodies, respectively, which are coupled to a third single body having the reflection mirror to reflect the image incident from the first single body to the second single body.

2. The projection lens unit of the projection TV of claim 1, wherein the first and second single bodies are coupled to first and second coupling portions, respectively, which are integrated with the third single body.

3. The projection lens unit of the projection TV of claim 2, wherein the first single body and the first coupling portion are coupled to each other by a screw coupling method.

4. The projection lens unit of the projection TV of claim 2, wherein the second single body and the second coupling portion are coupled to each other by a screw coupling method.

5. The projection lens unit of the projection TV of claim 3, wherein the first or second single body is coupled to the first or second coupling portion, respectively, by using the first or second single body as a male screw and by using the first or second coupling portion as a female screw.

6. The projection lens unit of the projection TV of claim 3, wherein the first single body and the first coupling portion, or the second single body and the second coupling portion are coupled by screws perpendicular or parallel to the respective optical axis.

7. The projection lens unit of the projection TV of claim 3, wherein the first single body and the first coupling portion are coupled to each other by using a first coupling device as a coupling medium, which is coupled to the first single body and the first coupling portion by the screw coupling method.

8. The projection lens unit of the projection TV of claim 4, wherein the second single body and the second coupling portion are coupled to each other by using a second coupling device as a coupling medium, which is coupled to the second single body and the second coupling portion by the screw coupling method.

9. The projection lens unit of the projection TV of claim 8, wherein the second coupling device is formed of a material that has a predetermined thermal expansion coefficient, and wherein the third single body is attached to the inner surface of the second coupling portion.

10. The projection lens unit of the projection TV of claim 1, wherein the reflection mirror is installed on an inner surface of the third single body.

11. The projection lens unit of the projection TV of claim 1, wherein the reflection mirror is installed on an outer surface of the third single body such that a reflection surface of the reflection mirror faces the inside of the third single body.

12. The projection lens unit of the projection TV of claim 11, wherein a slot is arranged on the outer surface of the third single body to insert the reflection mirror into the slot.

13. A projection TV, comprising:
an image generating source for generating an image;
a first body including a first lens assembly for receiving and focusing the image generated by the image generating source;
a reflection mirror for receiving and reflecting the image focused by the first lens assembly;
a second body including a second lens assembly for receiving, magnifying, and projecting the image reflected from the reflection mirror; and
a screen onto which the image magnified and projected by the second lens assembly is displayed;
wherein a third body, which includes the reflection mirror, is connected to the first body and to the second body;
wherein the first lens assembly has a first optical axis; and
wherein the second lens assembly has a second optical axis that is identical to the first optical axis of the first lens assembly.

14. The projection TV of claim 13, further comprising:
a first coupling portion coupled to the first body; and
a second coupling portion coupled to the second body;
wherein the first coupling portion and the second coupling portion are integral parts of the third body.

15. The projection TV of claim 14, wherein the first coupling portion is coupled to the first body by screw coupling means.

16. The projection TV of claim 14, wherein the second coupling portion is coupled to the second body by screw coupling means.

17. The projection TV of claim 14,
wherein the first body and the first coupling portion are structured as a first male screw and a first female screw, respectively, in order to couple the first body to the first coupling portion, and
wherein the second body and the second coupling portion are structured as a second male screw and a second female screw, respectively, in order to couple the second body to the second coupling portion.

18. The projection TV of claim 14, further comprising:
first screws arranged in at least one of a perpendicular direction and a parallel direction with respect to the first optical axis in order to couple the first body to the first coupling portion; and
second screws arranged in at least one of a perpendicular direction and a parallel direction with respect to the second optical axis in order to couple the second body to the second coupling portion.

19. The projection TV of claim 15, further comprising:
a first coupling device arranged between the first body and the first coupling portion in order to couple the first body to the first coupling portion by the screw coupling means.

20. The projection TV of claim 16, further comprising:
a second coupling device arranged between the second body and the second coupling portion in order to couple the second body to the second coupling portion by the screw coupling means.

21. The projection TV of claim 20, wherein the third body is attached to an inner surface of the second coupling device.

22. The projection TV of claim 13, wherein the reflection mirror is arranged at an inner surface of the third body.

23. The projection TV of claim 13, wherein the reflection mirror is arranged at an outer surface of the third body, and wherein the reflection mirror comprises a reflection surface that faces an inside of the third body.

24. The projection TV of claim 23, wherein the outer surface of the third body comprises a recess configured to receive the reflection mirror.
